(19) United States
(12) Patent Application Publication
(10) Pub. No.: US 2007/0253474 A1
(43) Pub. Date: Nov. 1, 2007

(54) GENERATING EYE-DIAGRAMS AND NETWORK PROTOCOL ANALYSIS OF A DATA SIGNAL

(75) Inventor: Dale Trenton Smith, San Jose, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 11/741,622

(22) Filed: Apr. 27, 2007

Related U.S. Application Data
(60) Provisional application No. 60/795,373, filed on Apr. 27, 2006.
(60) Provisional application No. 60/795,377, filed on Apr. 27, 2006.

(51) Int. Cl. H04B 17/00

(52) U.S. Cl. 375/228

(57) ABSTRACT

Methods and systems for generating an eye-diagram and performing network analysis for a signal. A signal can be sampled to obtain a set of signal samples. A maximum and minimum signal sample can be identified from the set of signal samples. The target can be calculated as a midpoint between the maximum signal sample and the minimum signal sample. This target can be used to sample the signal and construct an eye-diagram. A network protocol analyzer is also used to perform network protocol analysis of the signal. The eye-diagram and network protocol analysis may be shown together in a single display.

### CROSS-REFERENCE TO RELATED APPLICATIONS

This application claims the benefit of U.S. Provisional Application Ser. No. 60/795,373 filed on Apr. 27, 2006 and claims the benefit of U.S. Provisional Application Ser. No. 60/795,377 filed on Apr. 27, 2006, which applications are incorporated herein by reference in their entirety.

### BACKGROUND OF THE INVENTION

1. The Field of the Invention

The present invention relates generally to analysis of data transferred in a data transmission link.

2. The Relevant Technology

As the world becomes increasingly dependent on electronic data, there is an increased need for speed, bandwidth, and integrity in communication systems. Typically, various protocols are used to transfer data between the various components of a communication system. Examples of commonly used protocols are Fibre Channel, Gigabit Ethernet, Sonet, Infiniband, Rapid IO, PCI Xpress and others. Generally, the protocols are associated with a specific type of data communication. For example, the Fibre Channel protocol may be used to transfer data between storage area networks such as redundant array of inexpensive disk (RAID) systems, just a bunch of disks (JBOD) systems, workstations, and servers.

As network data moves from a point of origin to a destination by way of communication links, the network data passes through a variety of devices, representing multiple protocols and types of hardware. Typically, each device modifies the network data so that the network data can be transmitted by way of a particular communication link. However, modification of the network data in this manner often causes errors or other problems with the network data. Such errors may occur as the result of various other processes and conditions in the transmission mechanisms as well. Thus, the various links in a communications system may be particularly prone to introduce or contribute to the errors in the network data. Moreover, errors and other problems present at one location in the network data stream can cause additional errors or other problems to occur at other locations in the data stream and/or other points in the communications system and associated links.

One approach to the identification, analysis, and resolution of problems in communication systems involves capturing a portion of the network data traffic for review and analysis. In some cases, such data capture is performed in connection with an analyzer that includes various hardware and software elements configured to capture data from communications links in the communications system, and to present the captured data in various formats to a user or technician by way of a graphical user interface or other output device.

Generally, analyzers capture data traffic in the communications system over a defined period of time, or in connection with the occurrence of predefined events. Use of the analyzer may allow a network analyzer to track the progress of selected data as the data moves across the various links in the communication system. Corrupted or altered data can then be identified and traced to the problem link(s), or other parts of the communications system.

Another tool that can be used to analyze integrity of signals transmitted over a data transmission link is an oscilloscope. One way that an oscilloscope can be used is to present an eye-diagram of an optical signal to a user. An eye-diagram can be used to analyze a signal for many purposes and can provide a visual representation of whether an interconnect meets an eye-diagram test specification for a given standard. Well known purposes for presenting an eye-diagram are to provide a measurement of total jitter (deterministic and random jitter combined) and extinction ratio (ratio of average high to average low logic level). Jitter can indicate how frequency is changing from bit to bit. Jitter can be represented in an eye-diagram by the vertical slope of the eye-diagram. Modern sampling oscilloscopes can display the jitter histogram at the threshold crossing and can use “eye masks” to spot violations of jitter and amplitude noise for both Fibre Channel and Gigabit Ethernet. An eye-diagram typically displays multiple waveform crossings simultaneously on an overlaid time base. Characterization of an eye-diagram can include mask testing as well as other eye-diagram measurements.

Protocol analyzers often do not have the capability of generating eye diagrams and in conventional systems, oscilloscopes must be used. Thus, both an oscilloscope test apparatus and a network analyzer test apparatus may be required to perform a comprehensive analysis of the data and transmission link components. Thus, there is a need for a system and method of integrating the benefits of an eye diagram with a protocol analyzer.

### BRIEF SUMMARY OF THE INVENTION

The present invention relates to distributed analysis of network data. The method includes performing protocol analysis on the data signal, generating an eye-diagram, and displaying the results of the analysis together with the eye-diagram. The protocol analysis is performed by a protocol analyzer configured for analyzing data transferred in a network. The protocol analyzer can include a network processor configured to receive network data representing at least a portion of data stream transferred in a network link.

Together with the protocol analyzer, a method for generating an eye-diagram is disclosed. The method includes sampling a signal at a percentage of the harmonic frequency of the signal, with the harmonic frequency of the signal being equal to the bit-rate divided by an integer. The method further includes identifying the target as a midpoint between a maximum signal sample and the minimum signal sample. The method further includes constructing an eye-diagram using the trigger as a reference point by identifying a point where multiple waveform crossings are displayed simultaneously on an overlaid time base. The method further includes displaying the eye-diagram to at least one of a screen of a stand alone unit or a display of a network analyzer along with a result of network protocol analysis conducted by the network analyzer.

The invention also relates to a system for displaying an eye-diagram with results of the protocol analysis. The system includes a sampling device for sampling the signal. The apparatus further includes a memory for storing a set of the samples. The system further includes a processor including computer executable instructions that cause the processor to identify a trigger by causing the computer to perform the following when executed: query the set of samples stored in the memory to identify both a maximum sample value and a minimum sample value, identify the trigger by calculating a midpoint between the maximum sample value and the minimum sample value, and cause the processor to generate an eye-diagram using the trigger point as a reference point. The system also includes a network analyzer for generating and displaying the eye-diagram along with a result of network protocol analysis conducted by the network analyzer.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an example of a digital signal transmitted over a communications link along with points indicating locations where the signal can be sampled and recorded in order to generate an eye-diagram;

FIG. 1B illustrates an output of a sample and hold apparatus that can be used to hold the value of the sampled signal at that value for measurement and storage in memory;

FIG. 1C illustrates a representation of a signal that can be reconstructed from the periodic samples taken of the signal;

FIG. 2 illustrates a method for sampling a signal and constructing and displaying an eye-diagram according to an example embodiment of the present invention;

FIG. 3 is a chart illustrating example data structures that may be stored in memory corresponding to a sampling of a signal transmitted in a transmission link;

FIG. 4 illustrates a representation of the reconstructed signal produced by plotting the corresponding cycle position versus the amplitude points of the sampled data shown in FIG. 3;

FIG. 5 illustrates an eye-diagram along with a superimposed eye mask;

FIG. 6 illustrates a method for calculating a trigger according to an example embodiment of the present invention;

FIG. 7 illustrates an apparatus for displaying an eye-diagram along with data received from a monitoring interface of an optical transceiver according to an example embodiment of the present invention;

FIG. 8 illustrates an apparatus for displaying network protocol analysis results and information along with an eye-diagram and information received from a monitoring interface of a transceiver according to an example embodiment of the present invention;

FIG. 9 illustrates an example of a display screen according to an example embodiment of the present invention; and

FIG. 10 illustrates a method for displaying various types of information and data relevant to analyzing a data transmission link according to an example embodiment of the present invention.

### DETAILED DESCRIPTION OF THE PREFERRED EMBODIMENTS

Embodiments of the present invention relate to analysis of data transferred in a data transmission link. The principles of the present invention are described with reference to the attached drawings to illustrate the structure and operation of example embodiments used to implement the present invention. Using the diagrams and description in this manner to present the invention should not be construed as limiting its scope. Additional features and advantages of the invention will in part be obvious from the description, including the claims, or may be learned by the practice of the invention. Detailed descriptions of well-known components and processing techniques are omitted so as not to unnecessarily obscure the invention in detail.

An aspect of high speed signal transmission that some embodiments of the present invention are concerned with is utilizing the known bit-rate of a signal to construct an eye-diagram. Because the bit-rate of a signal is in many circumstances known and relatively constant, an eye-diagram can be constructed from an under-sampling of a signal taken at a known harmonic frequency of the signal bit-rate. These samples can be used to construct an eye-diagram that can be used for analysis of the data signal.

Another aspect of some embodiments of the present invention relate to is identifying a trigger point from samples of a signal, and using the trigger point as a reference to sample the signal and/or construct the eye-diagram. The trigger point can also be used with software to construct an eye-diagram from samples stored in memory. Some embodiments also include aspects of sampling a signal so as to ensure that at least one sample is received identifying the trigger point. One result of several aspects of the present invention is that eye-diagrams can be displayed, for example using a network protocol analyzer or a stand-alone unit.

Another embodiment of the present invention includes the ability to perform network protocol analysis using a network protocol analyzer. This can be accomplished, for example, using a single combined unit, or using a stand alone unit, and may involve creating a copy of the tapped signal and sending it to the network protocol analyzer while the other copy of the tapped signal is used to generate the eye diagram as mentioned above. Further, the network protocol analyzer may contain a plurality of analysis processors, each capable of performing analysis of specific portions of the network data.

The different aspects of the present invention can by carried out by many different methods, which can be practiced using many different apparatuses. Different embodiments of the present invention can also combine the different aspects of the present invention in various combinations and configurations. Thus, what follows are several examples of methods and apparatuses for practicing example embodiments of the present invention.

### A. Sampling a Data Signal for Generating an Eye-Diagram

According to example embodiments of the present invention, a percentage of a harmonic frequency of a bit-rate of a data transmission channel can be used to sample a signal and construct an eye-diagram. One way that this bit-rate can be used is by undersampling the signal transferred over a channel. In this manner, the steady harmonic frequency of the signal can be used to construct an eye-diagram using samples taken less frequently than prior art methods of using an oscilloscope and taking many samples per bit unit. As a result, protocol analyzers are enabled to display an eye-diagram of a high speed data signal.

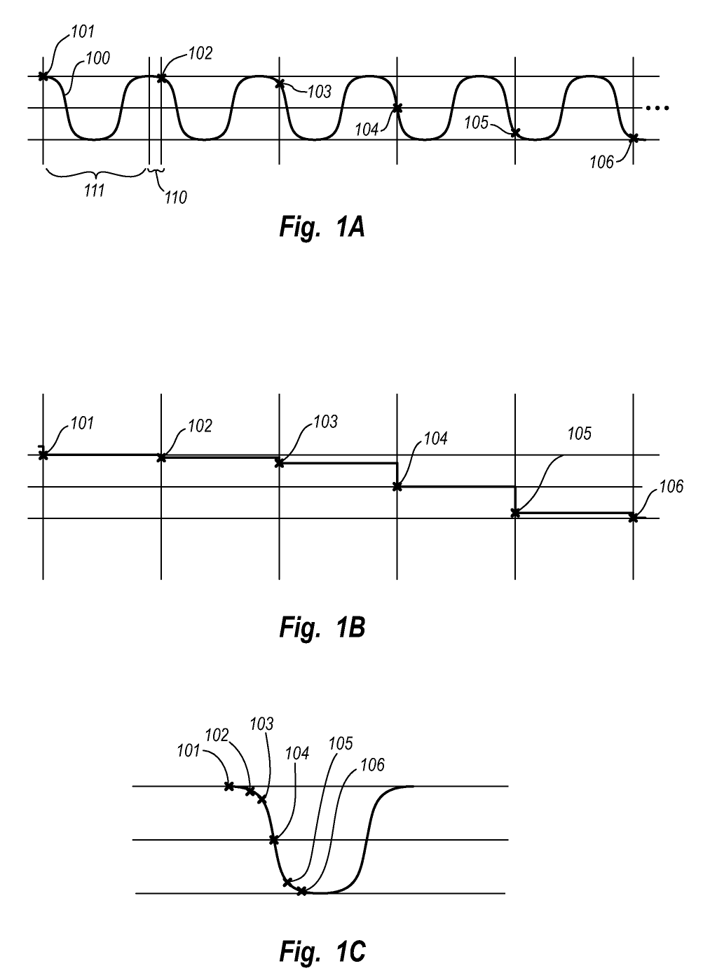

Referring to FIGS. 1A, 1B, and 1C, graphs illustrating various stages of methods for constructing an eye-diagram by under-sampling of a signal received from a communication link are shown according to an example embodiment of the present invention. Referring to FIG. 1A, an illustration of an example is shown of a signal transmitted over a communications link along with points 101-106 indicating locations where the signal can be sampled and recorded in order to reconstruct the signal shown in FIG. 1C for creating an eye-diagram.

Referring still to FIG. 1A, a first sample 101 is taken at a first point in time along a signal 100 transmitted in (or received from) a transmission link. A clock can control the frequency (110 added to 111) at which each sample 101-106 is taken, and each sample 101-106 can be taken at a percentage of a harmonic frequency 111 of the signal 100. For example, as shown in FIG. 1A the harmonic frequency (110 added to 111) of the samples 101-106 taken of the signal 100 is slightly slower 110 than the harmonic frequency 111 of the signal 100. As shown, a first sample 101 can be taken and recorded followed by a second sample 102 that is taken at a point in time slightly later 110 than the harmonic frequency 111 of the signal 100 (i.e., the harmonic frequency of the signal divided by the integer 1). Similarly, a third sample 103 of the signal 100 can be taken after the second sample 102 at a time that is slightly later in time than the harmonic frequency of the signal 100. The same process can be followed for a fourth signal sample 104, a fifth signal sample 105, a sixth signal sample 106, and so on until a sufficient number of samples (e.g., hundreds, thousands, or several hundreds of thousands of samples) have been taken to reconstruct a signal as illustrated, in part, in FIG. 1C. Often, it is useful to limit the number of samples, for example, to the order of about 1000 samples. While the harmonic frequency of the sampling shown in FIG. 1A is slightly slower than the harmonic frequency of the signal, it should be appreciated that the harmonic frequency of the sampling can be slightly faster or slightly slower than the harmonic frequency of the signal and can be divided by any integer to reduce the frequency of the sampling even more. For example, the harmonic frequency of the sampling can be slightly greater or slightly less than the harmonic frequency of the signal divided by an integer greater than 1, for example an integer between 2 and 100. The value of the integer can be any integer and can be determined based in part on the maximum speed of the components of the system sampling the signal.

Referring to FIG. 1B, a sample and hold apparatus (e.g., a sample and hold circuit) can be used to sample and hold the value of the signal for measurement and storage in memory. The value of a first sample 101 can be held until a second sample 102 is taken, at which point the sample and hold apparatus can hold the value at that second value 102 of the signal sampled until a third sample 103 is taken, and so on for samples 104-106, as illustrated in FIG. 1B. In this manner the speed of the apparatus converting the sampled analog value to a digital value and writing the sample values to memory does not need to be as fast as that described above for conventional eye-diagram generation systems.

Referring to FIG. 1C, a representation of a portion of a signal reconstructed from the periodic samples taken of FIGS. 1A and 1B is illustrated according to an example embodiment of the present invention. For example, referring to FIG. 1C, a first sample 101 can be plotted in time followed by the later samples 102-106. The distance in time between each sample 101-106 in FIG. 1C can correspond to a unitary step amount or frequency at which the samples are taken. Because many samples (e.g., hundreds, thousands, or hundreds of thousands of samples) can be taken at small unitary steps from the bit rate harmonic frequency (e.g., about 0.2% of a harmonic frequency) to reconstruct the eye-diagram, over time the accumulation of the samples can give a reasonably good depiction of an eye-diagram for purpose of analyzing the signal transmitted in the transmission link in a more cost-effective manner.

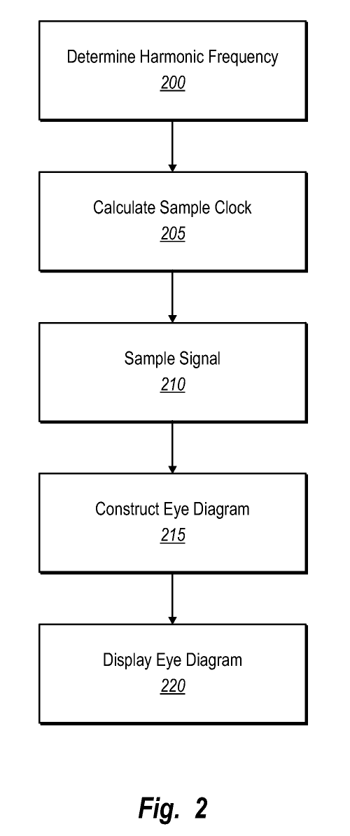

Referring now to FIG. 2, a block diagram is shown illustrating a method for constructing and displaying an eye-diagram according to an example embodiment of the present invention. A harmonic frequency can be determined (200). The harmonic frequency can be determined by dividing the bit-rate of a data signal by an integer to obtain a harmonic frequency that is within the maximum capabilities of every component (e.g., such as a maximum rate of an analog to digital converter or a maximum rate of a sample and hold apparatus or other device or circuit). For example, where the maximum sample rate of an analog to digital sampler is 200 MS/s, a 4.25 Gb/s bit-rate can be divided by the integer 22 to obtain a harmonic frequency of 193.18 MHz (i.e., 4250 MHz/22). A similar calculation can be made for any other bit rate, for example a bit rate between 1 Gb/s and 10 Gb/s. The integer can be any integer, for example an integer between 1 and 100.

A sample clock rate value can be calculated (205). The sample clock rate value can be based on the harmonic bit-rate calculated with the addition or subtraction of a desired unitary step precision for reconstructing the eye-diagram. The sample clock rate can be any percentage of a harmonic frequency of the bit-rate, for example between about 90 percent and 99.99 percent or between about 100.01 percent and 110 percent of a harmonic frequency of the bit-rate. According to an example embodiment, about 99.8% or 100.2% can be used, which gives a 0.2% unitary step precision to an eye-diagram generated from the samples. According to this preferred example, 99.8% of 1.93 MHz is 192.8 MHz, which gives a 0.2% resolution to the eye-diagram that is constructed from the samples. The signal can be sampled (210) at the calculated frequency. The signal can be sampled using a sample and hold apparatus, for example. The sample and hold apparatus can include a tap or other physical connection that samples the analog level of the signal, and a circuit that holds each analog level of the signal received until the next increment of the clock. The sampled value can be held steady while the value of the sample is determined. The value of the sample can be converted to a digital value and can be written to memory along with the value of other samples taken. Many samples can be taken and recorded to reconstruct a signal and/or display an eye-diagram.

In order to generate a useful eye diagram, it is important to place the data samples on the diagram with better than 1% accuracy. This is difficult because the eye mask 515 often takes up 67% of the sampled time period, leaving only 33% of the time period to generate the eye, and a sophisticated system will reduce the margin surrounding the eye to a small percentage of the total window. Thus, in order to generate useful data, it is necessary to compensate for multiple error sources. Some common errors include improperly identified trigger points due to non-symmetry of the waveform, deviations in the voltage of the signals, inaccurate or unknown signal frequencies, inaccurate or unknown sample frequencies, and an insufficient number of samples.

While each of these error sources may only introduce a slight amount of error to the system, their accumulated impact can be significant. Generally, the systems are sufficiently accurate for MHz frequencies and below, but there are added difficulties in Fibre Channel, SAS, SATA, or any other Gigabit bus systems. This is because the accuracy of the sample frequency is proportional to the number of bit times elapsed between the first and last sample. For example, if 23 samples are taken on 22-bit intervals, then it takes 484 bit times to generate an eye-diagram, and the diagram will only have 4.5% accuracy. Generally, such a system will only be useful for detecting large signal problems relating to the integrity of the system.

In order to detect smaller problems with the signal, the sampler will need to provide at least 100 samples or more to create the eye. Using the same method as above, if 100 samples are taken in 22-bit intervals, then it would take 2178 bit times for the first sample to last. Thus, for the eye sampler to have the desired 1% accuracy, the accuracy of the sample frequency relative to the signal frequency must be better than 1/(100*2178)=0.0000046. Since, most oscillators are accurate to only 0.000025, a PLL (i.e., a phase locked loop) or similar method may be used in order to filter the jitter to the scope trigger so that the displayed jitter is more correctly weighted.

The PLL locks onto the data frequency either through hardware or software. A PLL is often needed because real world clocks can vary, for example, from 25-100 ppm. Jitter introduces additional inaccuracies into the sampled signals and the sampling clock. The PLL enables a protocol analyzer to lock on to the actual data frequency. Then, the sampling described herein can be used to generate the eye diagram shown in FIG. 1C.

More generally, there are many sources of error that can affect the ability of a system to generate an eye diagram, particularly at the GigaHertz frequencies. The actual signal frequency may vary from the expected signal frequency. The actual sample frequency may differ from its nominal value. Thus, the accuracy of some methods may be further limited by the number of samples taken and the number of samples taken may be affected by the accuracy in identifying the signal frequency and in generating the desired sample frequency. Using a starting sample and an ending sample, and by using software to identify the actual ratio between the two frequencies (signal and sample), errors due to clock tolerances, temperature, and the like can be eliminated. These and other errors can also be eliminated in some embodiments using the methods disclosed in U.S. Pat. No. 6,181,267, which is incorporated by reference.

The data stored in memory can be converted into a format for display as an eye-diagram to a user (215). For example, the data points can be organized in time so that they conform to a time value depiction of the signal for purposes of displaying the eye-diagram. The eye-diagram can be constructed to display multiple waveform crossings of the signal simultaneously on an overlaid time base (i.e., an eye-diagram) using any method. The data points can also be converted to a compatible format for display depending on the type of display or output of the eye-diagram implemented.

The data can then be displayed as an eye-diagram (220). The eye-diagram can be displayed using a LCD screen of a stand alone unit, a monitor of a computer system, the display of a network protocol analyzer, the screen of a hand held device, or a hard copy produced by a printer, for example. The data can also be output to a file or other storage medium for accessing the data points themselves. For example, algorithms can be used in conjunction with the eye-diagram data to calculate jitter, to determine extinction ratio, to identify samples violating an eye mask, or for any other reason.

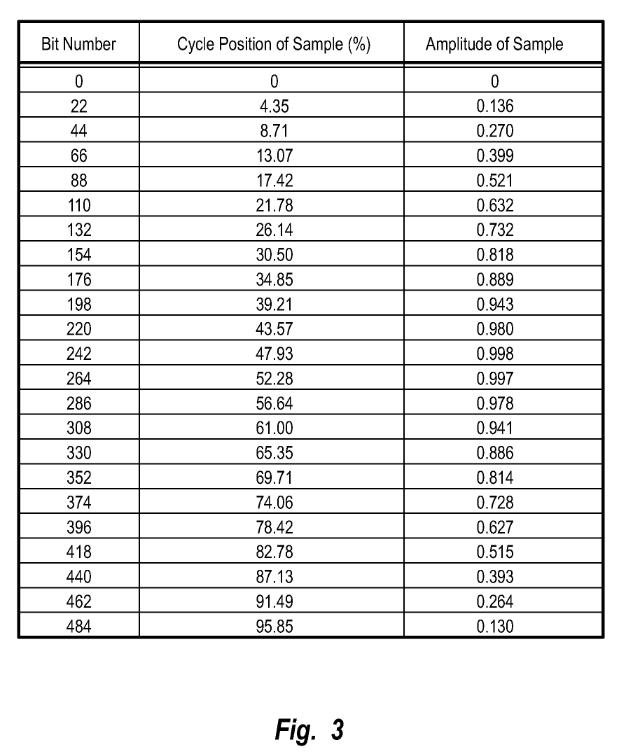

Referring to FIG. 3, a chart is shown illustrating an example of data structures that may be stored in memory corresponding to a sampling of a sine wave signal transmitted in a transmission link. The samples indicated in FIG. 3 illustrate methods for sampling signals according to the present invention, but are not necessarily indicative of an actual signal that would be received and sampled to reproduce a signal and/or display an eye-diagram. As shown in FIG. 3, a bit number can be stored indicating the bit, or harmonic cycle, at which the sample is taken. In this example, an integer of 22 is used to calculate the harmonic cycle of a clock corresponding to the rate of the sampling. Thus, each sample taken is separated by 21 signal bit units in this example.

Next, a cycle position of the sample can be recorded. The cycle position of the sample can correspond to the precision of the undersampling of the signal and the relative position of each sample along a cycle of the signal. For example, in this example a unitary step of about 4.35% (e.g., relating to 110 in FIG. 1A) is used to sample the data. The amplitude of the signal sample can also be recorded and associated with the cycle position to reconstruct the signal.

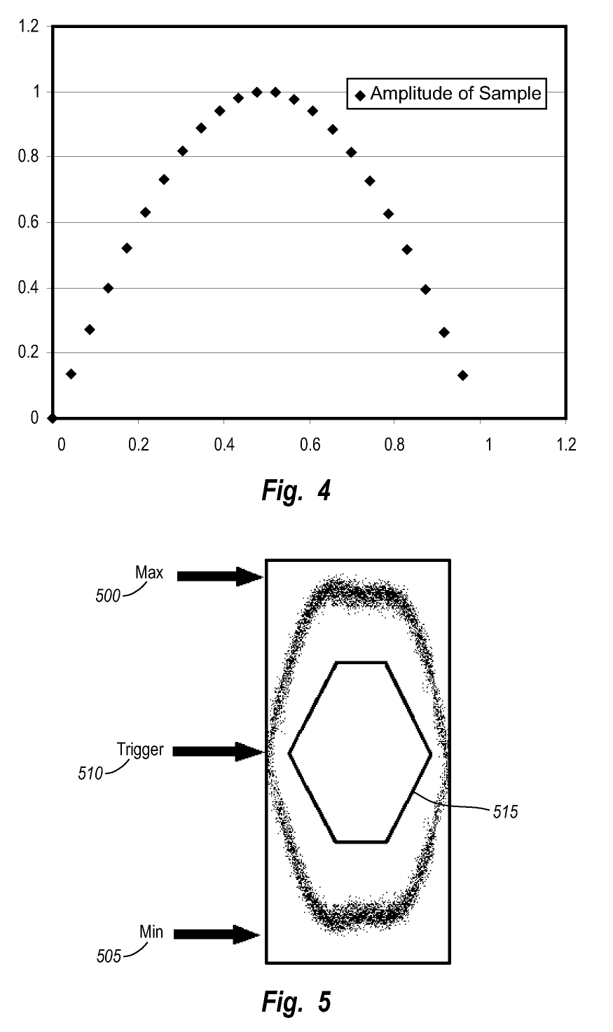

FIG. 4 illustrates a representation of the reconstructed sine wave produced by plotting the corresponding cycle position versus the amplitude points of the sampled data shown in FIG. 3. The reconstructed sine wave shown in FIG. 4 is not created from several samples of a single sine wave oscillation, but rather is a portion of a sine wave signal created from 23 samples taken every 22 bit units of a sine wave signal over 484 harmonic oscillations of the signal. Thus, according to some example embodiments of the present invention, an analogous method of sampling and reconstructing a signal can be implemented to create an eye-diagram that provides useful information in a more cost-effective manner than that which may be created by conventional methods, such as using an oscilloscope.

### B. Determining a Trigger Point for Eye-Diagram Generation

An aspect of some embodiments of the present invention can include methods and apparatuses for determining a trigger point for generating and displaying an eye-diagram. Referring to FIG. 5, an eye-diagram is illustrated along with a superimposed eye mask 515 indicating locations within the eye-diagram where receipt of a signal can cause a misinterpretation of the optical signal. As shown, the eye-diagram can be defined by a maximum value 500, a minimum value 505, and a trigger point 510. The trigger point 510 may need to be identified as a reference point in order to overlay the signal oscillations to construct the eye-diagram. According to some embodiments of the present invention, the trigger point 510 can be defined as a point where the eye-diagram passes a midpoint between the maximum 500 and minimum 505 level of the eye-diagram. This trigger point is not necessarily the point where the bit is determined to be a “1” or a “0”, but is a trigger point used in reconstruction of the eye diagram.

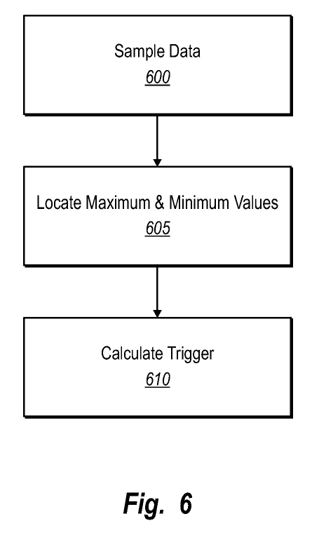

Referring to FIG. 6, a block diagram illustrating a method for identifying a trigger is shown according to an example embodiment of the present invention. A signal transmitted in a communication link can be sampled (600). The signal can be sampled using a tap and hold apparatus. The signal can be sampled several times per bit unit interval, or the data can be sampled using methods of undersampling to reconstruct the signal as discussed in further detail herein. The sampled data can be stored in memory, and many samples of the data signal can be recorded in order to ensure that enough samples are obtained to construct the eye-diagram.

Maximum and minimum values of the eye-diagram can be identified (605). Many samples of data can be queried to determine a maximum and minimum value sampled. The maximum and minimum values of a signal can also correspond to the maximum and minimum values of an eye-diagram that is generated as illustrated in FIG. 5. With continued reference to FIG. 6, once the maximum and minimum values are identified (605), a trigger point (i.e., a mid-point) can be calculated (610). The trigger point can be equal to the midpoint between the maximum eye-diagram value and the minimum eye-diagram value. The trigger can be calculated by dividing the difference of the minimum eye-diagram value and the maximum eye-diagram value by two and adding this value to the value of the minimum sample value.

For example, assume that a maximum sampled eye-diagram value is 2.2 volts and a minimum sampled eye-diagram value is 1.0 volts. Dividing the difference between the maximum and minimum values of the eye-diagram by two and adding this value to the minimum eye-diagram value yields a trigger point of 1.6 volts. This trigger point can then be used in conjunction with logic in a FPGA, or other trigger device, to trigger on an analog or digital output of 1.6 volts and sample a signal to overlay oscillations of the signal and create an eye-diagram. Where the bit-rate of the optical signal is known, the FPGA can begin sampling the signal and communicate with a display controller to overlay the signal oscillations in an eye-diagram display. In this manner, the trigger point calculated can be used as a reference point to sample the signal and generate the eye-diagram.

According to other embodiments of the present invention, the trigger point can also be used in conjunction with a set of signal samples stored in memory to construct an eye-diagram for the signal sampled. The samples can be taken at an under sampled harmonic rate of the signal bit-rate. In another embodiment, the many samples can be sampled at a known fraction of the frequency of the signal and then reconstructed about the trigger point to construct the eye-diagram. This method requires a large enough memory to store the many samples of data needed to construct the eye-diagram, and sufficient processing power to process the sampled data and generate the eye-diagram.

### C. Displaying Protocol Analysis Using Network Protocol Analyzers

According one embodiment of the present invention, data representing at least a portion of a data stream transferred in a network link can be transferred to a network processor, where the network processor prepares the network data for analysis. This can include associating the data with an identifier. The network analyzer can further include a distribution module coupled to the network processor configured to receive the network data from the network processor, the distribution module configured to route the network data to at least one of a plurality of distribution module outputs based on the identifier or based on a path control signal generated by a network processor. The network analyzer can further include a plurality of analysis processors coupled to the distribution module, each analysis processor couple to a different output of the distribution module for receiving network data from a different output of the distribution module, each analysis processor performing analysis of specific portions of the network data. This protocol analysis can then be displayed along with an eye-diagram in a single unit. According to several embodiments of the present invention, signals from a monitoring interface can be received and at least a portion of the network protocol analysis results and information can be displayed along with an eye-diagram.

A network protocol analyzer can analyze a variety of different layers of the network data transmission to locate errors caused by different mechanisms and processes. Other uses of protocol analysis include detecting network intrusion attempts, monitoring network usage, gathering and reporting network statistics, filtering suspect content, and debugging client/server communications. Currently, any number of network protocol analyzers may be used in association with the present invention. One such protocol analyzer is described in co-pending U.S. utility patent application Ser. No. 11/138,600 entitled “DISTRIBUTED STREAM ANALYSIS USING GENERAL PURPOSE PROCESSORS” which is expressly incorporated herein by reference in its entirety.

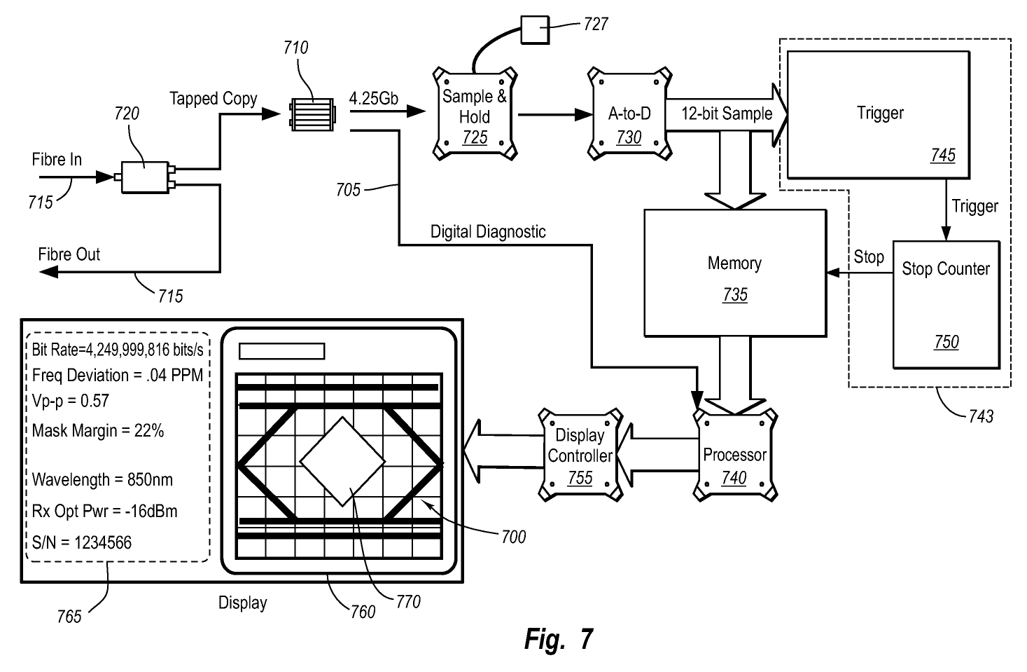

According to another embodiment of the present invention, data a processor and display, or other apparatus, can be implemented to display the diagnostic data along with the eye-diagram and along with network protocol analysis results. Example embodiments of the present invention can include combining methods and apparatuses for displaying transceiver diagnostic data along with other aspects of the present invention discussed herein. In the following examples, embodiments of the invention can use a hardware based PLL and/or a software based PLL. A software PLL can determine the actual frequency as part of the process of displaying the sampled data points. For example, referring to FIG. 7, an apparatus for displaying an eye-diagram 700 along with data 705 received from a monitoring interface of an optical transceiver 710 is shown according to an example embodiment of the present invention. A signal transmitted in a transmission link 715 can be received by a tapping device 720. A copy of the signal can be transmitted to the transceiver 710 while the signal is allowed to continue along the transmission link 715 to its destination, or can be reproduced and transmitted along the communication link 715 depending on the type of tap used.

The tapped copy of the signal can be received by the transceiver 710 (e.g., a SFP or GBIC transceiver module) having a monitoring interface. The signal can be transmitted from the transceiver 710 to a sample and hold device 725, such as a sample and hold circuit, that can sample the signal at a predetermined rate and hold the value of each sample for an analog to digital converter 730 to measure and store the sample in a memory 735. The sample and hold device 725 can under-sample the signal received from the transceiver 710 at a percentage of a harmonic frequency of the bit-rate of the signal. The sample rate can be controlled by a clock 727. The clock 727 can be any timing device. The sample rate of the sample and hold device 725 can be designated for a particular bit-rate of an optical channel, or the sample and hold device 725 can sample the signal at several different frequencies for several different bit-rates of different optical channels. The frequency of the sampling of the sample and hold device 725 can be determined by the clock 727 that can be part of the sample and hold device 725, or the clock 727 can be located externally to the sample and hold device 725 as shown. The frequency of the sampling of the sample and hold device 725 can also be determined at least in part based on the maximum rate of any component of the system, such as for example the maximum sample rate of the sample and hold device 725 or the maximum operating rate of the analog to digital converter 730.

The memory 735 can receive the samples (e.g., 12 bit samples) from the analog to digital converter 730 and store the samples in memory 735 for access by a processor 740. A trigger point can be identified. For example, the samples of data can be queried to determine a maximum value and a minimum value sampled. A location of a trigger can be calculated by dividing the difference between the minimum sample value and the maximum sample value by two and adding this value to the value of the minimum sample value.

Different methods and apparatuses can be used to construct the eye-diagram of the signal using the trigger. An optional triggering apparatus 743 can be coupled to the analog to digital converter 730 and can receive the data from the analog to digital converter 730 and lock on a trigger point within the signal received to help construct the eye-diagram as it received by the memory 735. A trigger 745 can transmit the trigger signal to a stop counter 750 that stops after a sufficient amount of samples have been saved in the memory 735. The processor 740 can then process the data stored in the memory 735, generate the eye-diagram 700, and output the eye-diagram 700 to a display controller 755 that displays the eye-diagram 700 on a display 760 (e.g., an LCD display of a stand alone unit or a display of a network analyzer).

According to embodiments of the present invention, the signal 705 from the monitoring interface of the transceiver 710 can also be received by the processor 740. The processor 740 can interpret the signals 705 received (e.g., including fields and identifiers such as those illustrated above in Table 1) and transmit data to the display controller 755 such that information received from the monitoring interface is displayed on at least a portion 765 of the display 760 along with, or separate from, the eye-diagram 700.

Other embodiments of the present invention can be similar to that described above except that the optional trigger 745 and stop counter 750 can be excluded, or not used. The processor 740 can calculate a trigger and construct the eye-diagram 700 from a number of samples stored in the memory 735. For example, the sample and hold device 725 can sample the signal that is transmitted at a known bit-rate. The sample and hold device 725 can sample the signal at a unit step to ensure that a trigger point will be sampled based on the amount of time that it takes for the signal to transition across the midpoint. For example, a sample unit step of about 0.2% of the bit-rate unit may be sufficient in some instances to ensure that the trigger point is sampled. In some instances, higher and lower unit steps can be used to ensure that the midpoint is sampled. This may depend on the amount of time it takes for the signal to transition between a high value and a low value or vice versa. This duration can be used to calculate the number of samples per bit unit needed to ensure that the trigger point is sampled according to example embodiments of the present invention.

Undersampling can also be used to ensure that the trigger point is sampled while still allowing for cost-effective equipment, such as a lower speed display 760, a lower speed sample and hold device 725, and/or a lower speed analog to digital converter 730 to be used. For example, the frequency of the sampling of the signal can be conducted slightly faster or slightly slower than a harmonic frequency (e.g., 111 in FIG. 1A) of the signal bit-rate at a unit step (e.g., 110 in FIG. 1A) so as to ensure that the trigger point is sampled. The harmonic frequency of the sampling can be the harmonic frequency of the signal divided by an integer and multiplied by a percentage other than 100%.

Samples of the signal can be stored in the memory 735 and the processor 740 can access the samples and locate a trigger point. Because the sample rate of the sample and hold device 725 is known along with the bit-rate of the signal, the eye-diagram 700 can be generated by the processor 740 by reconstructing the data into a signal that provides information (e.g., jitter) about the signal similar to that which would have been provided using conventional methods of constructing an eye-diagram.

The eye-diagram data can be transmitted to a display controller 755 along with the digital diagnostic data 705 received from the monitoring interface. The display controller can output the data received from the processor 740 to the display 760 in the form of an eye-diagram 700 and/or the data 765 received from the monitoring interface of the transceiver 710. An eye mask 770 or other tools for analyzing the eye-diagram 700 can also be displayed as well as other useful information for analyzing the signal.

Embodiments of the present invention can be a stand-alone unit combined with a conventional or special purpose network analysis device. When combined with a network protocol analysis device, additional information can be displayed related to network protocol analysis conducted and results of the network protocol analysis. This network protocol analysis information is displayed along with an eye-diagram and/or diagnostic data received from a diagnostic bus as discussed herein.

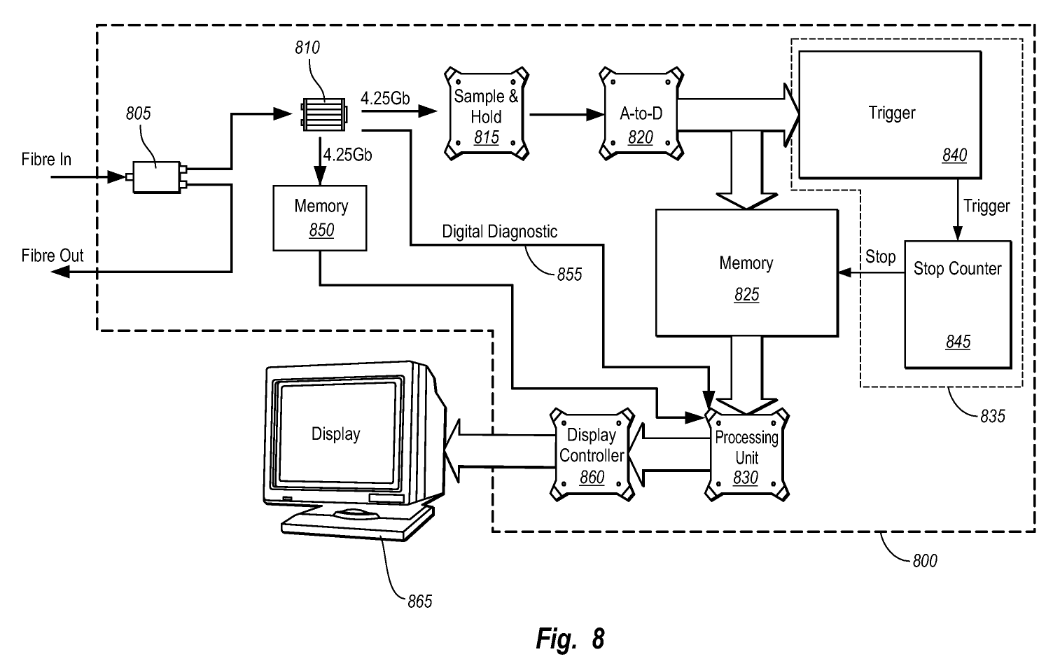

For example, referring to FIG. 8, an apparatus 800 for displaying network protocol analysis results and information along with an eye-diagram and information received from a monitoring interface of a transceiver is illustrated according to the present invention. A signal transmitted in a transmission link can be received by a tap 805 or other device for receiving and/or producing a copy of the signal. It should be appreciated that the tap 805 can be eliminated where it is not necessary to make a copy of the signal and allow the signal to continue on to its destination. In this embodiment, a tapped copy of the signal can be received by a transceiver 810. The transceiver can produce two copies of the signal. A first copy of the signal can be received by a sample and hold device 815 that samples the analog signal and can provide the analog samples to an analog to digital converter 820. The analog to digital converter 820 can convert the analog samples received from the sample and hold device 815 into digital samples. The analog to digital converter 820 can store the digital samples in a memory 825 for access by a processing unit 830. The analog to digital converter 820 can also forward the samples to an optional trigger apparatus 835 including a trigger 840 and a stop counter 845 for identifying trigger values within the samples as they are received and storing the data within the memory 825 along with data indicating a trigger point of the signal.

The processor 830 can access the samples in the memory 825 and construct an eye-diagram. A software PLL that determined the actual frequency of the signal may be used in the construction of the eye-diagram. A second copy of the signal is stored within a second memory 850 accessible by the processing unit 830 for network protocol analysis. It should be appreciated that the data stored for network protocol analysis can be stored in the same memory 825 as the data for construction of the eye-diagram. Any of the data can be stored in multiple memory buffers. The processing unit 830 can conduct network protocol analysis of the data stored in the memory 850 (or the data stored in memory 825). The network protocol analysis can be any type of network protocol analysis known to one of ordinary skill in the art. For example, the network protocol analysis can include network analysis using commercially available software and hardware.

For example, network protocol analysis can include debugging, reporting, and performance analysis tests and software. This can further include, for example, checking for bit errors, dropped frames, in-order delivery, troubleshooting network problems, identifying performance issues, upper layer protocol issues, logical, physical, and application layer issues, performance metrics and problems, symptoms of network problems, data errors, debugging applications, monitoring network traffic for performance, bandwidth usage, security analysis, analyzing network traffic to trace specific transactions or find security breaches, monitoring employee use and access, email communication, checking packet integrity, validating checksum and other fields of packets, monitoring transactions for policy purposes, decoding network and application protocols as are known in the art. Network protocol analysis can also include providing the user with graphical views, results of analysis, providing recommendations, or suggesting corrective actions.

Digital diagnostic data 855 can be received by the processing unit 830 from a monitoring interface of the transceiver 810. The digital diagnostic data 855 can describe several parameters of the optical signal, the optical communication link, and/or the hardware such as the transceiver 810. The processor 830 can conduct additional analysis and/or interpretation of the data 855 received from the monitoring interface prior to displaying the data 855 on the display 865. The processing unit can transmit eye-diagram data along with network protocol analysis data, and digital diagnostic data to a display controller 860 for controlling display of this information to a user using the display 865 (e.g., a LCD screen or a monitor).

An apparatus according to the present invention can include hardware for performing any aspect of the present invention in any combination or configuration. For example, apparatuses can display only an eye-diagram generated using any method along with data received from a monitoring interface of a transceiver and network protocol analysis results or information. Moreover, data received from a monitoring interface of a transceiver can be displayed independent of, or in combination with an eye-diagram and network protocol analysis results or information.

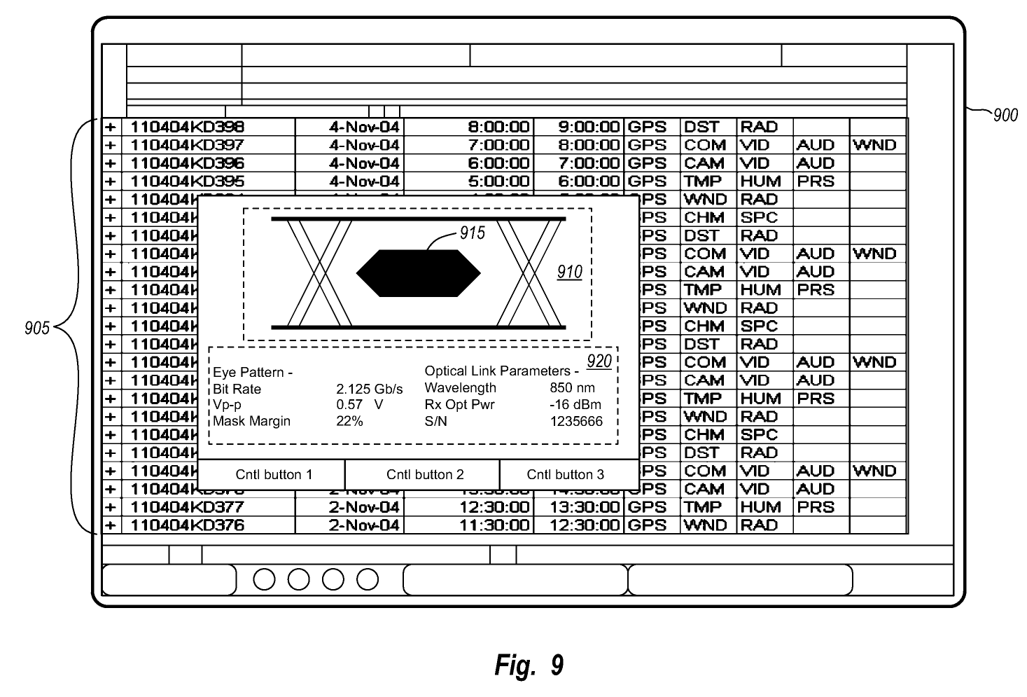

Referring to FIG. 9, an example of a display screen 900 is illustrated according to an example embodiment of the present invention. As shown, the display screen 900 can display various types of information for use in analyzing a transmission link and signal. The display 900 can display network protocol analysis results 905. The display 900 can also display an eye-diagram 910 for a signal. The eye-diagram 910 can include additional features and information such as an eye mask 915 for identifying portions of the eye-diagram 910 that may result in a misinterpretation of the data signal. The display 900 can also display additional information 920 including digital diagnostic information received from a monitoring interface of a transceiver.

The different types of information can be displayed as a selectable option to a user, or can be default settings by a manufacturer. For example, display of the eye-diagram 910, eye mask 915, digital diagnostic data 920, network protocol analysis results 905, etc. can each be optional, and display of the different types of data, as well as parameters for conducting analysis or generation of the eye-diagram, can be selectable by a user.

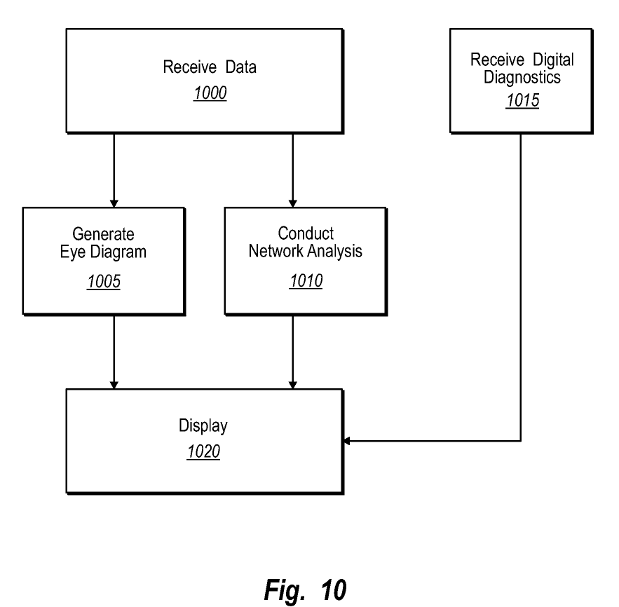

Referring to FIG. 10, a method for displaying various types of information and data relevant to analyzing a data transmission link and signal is shown according to an example embodiment of the present invention. A signal transmitted in a transmission link can be received (1000). The signal can be received by a tap, or other physical connection to the transmission link. At least one copy of the signal can be produced and a copy can be forwarded to a processor for network protocol analysis of the signal. The signal intended for network protocol analysis can be stored in a memory buffer for access by the processor conducting the network protocol analysis.

The copy of the signal, or another copy of the signal, can be received by a sample and hold or other sampling device. The sample and hold device can hold the value of the signal for an analog to digital converter to measure and convert from an analog sample value to a digital sample value. The analog to digital converter can store the digital samples in a memory for access by a processor. The memory can be the same memory that stores the data for network protocol analysis, or the memory can be a different memory than that which stores the data for network protocol analysis. An optional trigger apparatus can be used to identify a trigger sample value and trigger sampling of the data on the trigger point. According to another embodiment, a large amount of samples can be taken for generating the eye-diagram. For example the signal can be sampled at a fraction or multiple (i.e., under-sampling) of a harmonic frequency of the bit-rate of the signal transmission rate.

An eye-diagram can be generated from the data (1005). The eye-diagram can be generated by locating the trigger point and sampling the signal to construct the eye-diagram in the instance that the optional trigger and stop counter were used by over lacing oscillations of unit bits of the signal. A processor can also analyze the data to determine a trigger point. The trigger point can be identified by locating a maximum and minimum value of the eye-diagram and calculating a mid point in between the maximum and minimum points. An eye-diagram can be generated from this data using the trigger as a reference point.

Network protocol analysis can be conducted on the data (1010). Network protocol analysis can be conducted by the same processor as the processor used for generation of the eye-diagram, or a different processor (or multiple processors) can be used for network protocol analysis than that which constructs the eye-diagram.

Optionally, digital diagnostics data can be received (1015). The digital diagnostics can be any type of data received from a monitoring interface of an optical transceiver (e.g., a SFP or GBIC transceiver), such as a transceiver digital diagnostics bus for example. The eye-diagram can be displayed along with the network protocol analysis and the digital diagnostics data (1020).

Embodiments of the present invention may include or be conducted using a special purpose or general-purpose computer, processor, or logic device including various computer hardware and devices, as discussed in greater detail herein or known to one of ordinary skill. Embodiments within the scope of the present invention can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose computer, special purpose computer, or other logic device. When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a communications system, a method for displaying information describing a signal transmitted in the communication system, the method comprising:
receiving the signal with a tapping device;
transmitting the signal to a network protocol analyzer, the network protocol analyzer including an interface for performing protocol analysis of the signal;
constructing an eye-diagram of the signal; and
displaying the protocol analysis data received from the monitoring interface of the transceiver together with the eye-diagram of the signal.

2. A method according to claim 1, wherein constructing an eye-diagram of the signal comprises:
identifying a maximum signal sample from the set of signal samples;
identifying a minimum signal sample from the set of signal samples;
identifying a target as a midpoint between the maximum signal sample and the minimum signal sample; and
using the target as a reference point by identifying a point where multiple waveform crossings are displayed simultaneously on an overlaid time base.

3. The method according to claim 2, wherein the target is identified by adding half the difference between the maximum signal sample and the minimum signal sample value to the minimum signal value.

4. The method according to claim 3, wherein the eye-diagram is generated from the set of samples stored to memory.

5. A method according to claim 1, wherein the eye-diagram is generated by sampling the signal using the target as a target point when the signal is sampled to overlay the oscillations of the signal and generate the eye-diagram.

6. The method according to claim 1, wherein the network analyzer includes a network processor configured to receive the network data, a distribution module coupled to the network processor configured to receive the network data from the network processor, and a plurality of analysis processors each for performing analysis of specific portions of the network data.

7. The method according to claim 1, where the signal represents a signal transmitted over a Fibre Channel link or an Ethernet link.

8. The method according to claim 1, where the signal represents a signal transmitted at a rate between about 1 Gigabyte per second and 10 Gigabytes per second.

9. The method for according to claim 1, further comprising at least one of the acts of measuring jitter, measuring extinction ration, or performing a mask test.

10. In a communications system, a method for displaying information describing a signal transmitted in the communication system, the method comprising the following:
receiving the signal with a tapping device;
transmitting the signal to a network protocol analyzer, the network protocol analyzer including an interface for performing protocol analysis of the signal;
sampling the signal at a percentage of the harmonic frequency of the signal, the harmonic frequency of the signal being equal to the bit-rate divided by an integer;
identifying a target as a midpoint between a maximum signal sample and the minimum signal sample;
constructing an eye-diagram using the target as a reference point by identifying a point where multiple waveform crossings are displayed simultaneously in an overlaid time base; and
displaying the protocol analysis data received from the monitoring interface of the transceiver together with the eye-diagram of the signal.

11. The method according to claim 10, wherein the target is identified by adding half the difference between the maximum signal sample and the minimum signal sample value to the minimum signal value.

12. The method according to claim 10, wherein the eye-diagram is generated from the set of samples stored to memory.

13. A method according to claim 10, wherein the eye-diagram is generated by sampling the signal using the target as a reference point when the signal is sampled to overlay the oscillations of the signal and generate the eye-diagram.

14. A method according to claim 10, wherein the signal sampling percentage is between about 90 percent and 99.99 percent or between about 100.01 percent and 110 percent.

15. The method according to claim 10, where the integer is between 1 and 100.

16. The method according to claim 10, where the signal represents a signal transmitted over a Fibre Channel link or an Ethernet link.

17. The method according to claim 10, where the signal represents a signal transmitted at a rate between about 1 Gigabyte per second and 10 Gigabytes per second.

18. The method for according to claim 10, further comprising at least one of the acts of measuring jitter, measuring extinction ration, or performing a mask test.

19. The method according to claim 10, wherein the network analyzer includes a network processor configured to receive the network data, a distribution module coupled to the network processor configured to receive the network data from the network processor, and a plurality of analysis processors each for performing analysis of specific portions of the network data.

20. A system for displaying information describing a signal transmitted in the communication system, the system comprising:
a sampling device for sampling the signal;
a memory for storing a set of the samples;
a processor comprising:
computer executable instructions that cause the processor to identify a trigger by causing the computer to perform the following acts when executed:
query the set of samples stored in the memory to identify both a maximum sample value and a minimum sample value; and
identify the trigger by calculating a midpoint between the maximum sample value and the minimum sample value; and
generate an eye-diagram using the trigger point as a reference point;
computer executable instructions that cause a network analyzer to perform network protocol analysis of the data sample when executed; and
a network analyzer for generating and displaying the eye-diagram along with a result of network protocol analysis conducted by the network analyzer.
